(19) United States
(12) Patent Application Publication
(10) Pub. No.: US 2018/0196948 A1
(43) Pub. Date: Jul. 12, 2018

(54) DISTRIBUTED AND DECENTRALIZED CLOUND STORAGE SYSTEM AND METHOD THEREOF

(71) Applicant: Isuncloud Limited, Hong Kong (HK)

(72) Inventors: Ping Chen, Hong Kong (HK); Jun Ma, Hong Kong (HK)

(21) Appl. No.: 15/403,930

(22) Filed: Jan. 11, 2017

(51) Int. Cl. G06F 21/60; H04L 29/06; H04L 9/30; G06Q 20/10

(52) U.S. Cl. CPC G06F 21/602; G06Q 20/10; H04L 9/30; H04L 63/10

(57) ABSTRACT

A distributed and decentralized cloud storage method, which comprises: dynamically establishing a set of private notes (‘PN”) after a service requiring note (“SRN”) releasing a cloud storage requirement, wherein the PN comprises a plurality of service providing notes (“SPN”), and the service providing note provides storage space for the SRN; the SRN signing a storage contact with the plurality of SPN of the PN; the SRN performing slicing and encrypting process to a file to be stored, and sending a plurality of sub-files obtained from the process to the plurality of SPN which sign the storage contact with the SRN respectively; and each SPN storing the sub-files received to accomplish the distributed cloud storage of the file to be stored. Compared with the prior art, the method of the present invention solves the problems of low accessing speed and unsecured privacy, hence improves security of cloud storage.

### FIELD OF THE INVENTION

The present invention relates to the field of communication technology, and more particularly to a distributed and decentralized cloud storage system and method thereof.

### BACKGROUND OF THE INVENTION

With the rapid development of Internet economy, a large amount of unstructured data is produced in various fields of social production and social activities. Enterprises and IT practitioners feel increasing stress on data storage when facing explosive growth of these big data. Accordingly, distributed cloud storage system came into being. The distributed cloud storage system is a file sharing storage platform with a large storage space and supports flexible extensions and advanced performance access.

However, in the prior art, most of the distributed cloud storage systems adopt a centralized and distributed cloud storage system. Since this storage system adopts centralized management and is not a completely distributed architecture, there are the problems of unsecured privacy and low accessing speed. Further, all the data is forwarded via the control center, thus the efficiency is very low, and it is inevitably caught in bottleneck when facing a large number of concurrent forwarding. For this purpose, a few cloud service developers try the mode of inviting ordinary users to provide storage services. However, the management is also centralized, and the problems of unsecured privacy and low accessing speed are still not solved.

Therefore, it is necessary to provide a distributed and decentralized cloud storage system and method thereof to solve above problems.

### SUMMARY OF THE INVENTION

The object of the present invention is to solve the technical problems of unsecured privacy and low accessing speed in the prior art due to centralized and distributed cloud storage method.

In order to realize above object, a distributed and decentralized cloud storage method is provided in the present invention. The method comprises the following steps:

dynamically establishing a set of private notes after a service requiring note releasing a cloud storage requirement, wherein the set of private notes comprises a plurality of service providing notes, and the service providing note provides storage space for the service requiring note;

the service requiring note signing a storage contact with the plurality of service providing notes of the set of private notes;

the service requiring note performing slicing and encrypting process to a file to be stored, and sending a plurality of sub-files obtained from the process to the plurality of service providing notes which sign the storage contact with the service requiring note respectively; and

each service providing note storing the sub-files received to accomplish the distributed cloud storage of the file to be stored.

Advantageously, the method further comprises the following step after dynamically establishing the set of private notes:

selecting at least two service providing notes from the set of private notes as an arbitration note and a finance note respectively; and

the method further comprises the following step after the service requiring note signs a storage contact with the plurality of service providing notes of the set of private notes:

the service requiring note informing the arbitration note and the finance note list information of the service providing notes that sign the storage contact with the service requiring note, and the finance note determining payment information according to the storage contact and the list information.

Advantageously, the storage contact comprises a storage cycle and service fee of the file to be stored;

the method further comprises the following steps after each service providing note stores the sub-files received to accomplish the distributed cloud storage of the file to be stored:

the finance note actually paying service fee according to the payment information when the storage cycle of the file to be stored ends; and

the arbitration note informing the finance note to evaluate quality of service of the service requiring note and each service providing note.

Advantageously, the method further comprises the following steps after the service requiring note performs slicing and encrypting process to the file to be stored, and sends the plurality of sub-files obtained from the process to the plurality of service providing notes which sign the storage contact with the service requiring note respectively:

the service requiring note establishing and storing index information of the file to be stored, wherein the index information comprises a quantity of the sub-files, a combination sequence of the sub-files, secret keys corresponding to the sub-files, a storage location of the sub-files and operation authorization of the sub-files; and

the service requiring note sending the storage location and operation authorization of the sub-files to the arbitration note such that the arbitration note tracks a routine of the distributed cloud storage.

Advantageously, the method further comprises the following step after the service requiring note establishes and stores index information of the file to be stored:

the service requiring note broadcasting the index information to any one of the service providing notes such that the service providing note shares the file to be stored.

Advantageously, the method further comprises the following steps after the service requiring note performs slicing and encrypting process to the file to be stored, and sends the plurality of sub-files obtained from the process to the plurality of service providing notes which sign the storage contact with the service requiring note respectively:

the arbitration note judging whether the service providing notes are time-out or not while receiving corresponding sub-files; and

if a judging result is that the service providing notes are time-out, notifying the service requiring note, querying the service providing notes that are available at the present according to authorization information and predetermined conditions fed back from the service requiring note and storing the sub-files in the service providing notes that are available.

Advantageously, the method further comprises the following steps between the service requiring note releasing the cloud storage requirement and dynamically establishing the set of private notes:

the service requiring note generating an ID that identifies the service requiring note according to at least a pair of preset private key and public key;

the service providing note generating an ID that identifies the service providing note according to at least a pair of preset private key and public key.

Advantageously, each service providing note storing the sub-files received to accomplish the distributed cloud storage of the file to be stored comprises:

dividing the service providing notes of the set of private notes into a plurality of sub-set of notes;

sending all the sub-files of the file to be stored to the plurality of sub-set of notes respectively for multiple backups of the file to be stored.

Advantageously, the method further comprises the following step after sending all the sub-files of the file to be stored to the plurality of sub-set of notes respectively for multiple backups of the file to be stored:

synchronously reading the sub-files of the file to be stored from the plurality of sub-set of notes when reading the file to be stored, wherein a reading frequency of the sub-files is set in the service providing note.

A distributed and decentralized cloud storage method is further provided in the present invention, which comprising the following steps:

a service requiring note generating an ID that identifies the service requiring note according to at least a pair of preset private key and public key, and a service providing note generating an ID that identifies the service providing note according to at least a pair of preset private key and public key;

dynamically establishing a set of private notes after the service requiring note releasing a cloud storage requirement, wherein the set of private notes comprises a plurality of service providing notes, and the service providing note provides storage space for the service requiring note;

selecting at least two service providing notes from the set of private notes as an arbitration note and a finance note respectively;

the service requiring note signing a storage contact with the plurality of service providing notes of the set of private notes, wherein the storage contact comprises a storage cycle and service fee of the file to be stored;

the service requiring note informing the arbitration note and the finance note list information of the service providing notes that sign the storage contact with the service requiring note, and the finance note determining payment information according to the storage contact and the list information;

the service requiring note performing slicing and encrypting process to a file to be stored, and sending a plurality of sub-files obtained from the process to the plurality of service providing notes which sign the storage contact with the service requiring note respectively;

each service providing note storing the sub-files received;

the finance note actually paying service fee according to the payment information when the storage cycle of the file to be stored ends; and

the arbitration note informing the finance note to evaluate quality of service of the service requiring note and each service providing note.

Advantageously, the method further comprises the following steps after the service requiring note performs slicing and encrypting process to the file to be stored, and sends the plurality of sub-files obtained from the process to the plurality of service providing notes which sign the storage contact with the service requiring note respectively:

the service requiring note establishing and storing index information of the file to be stored, wherein the index information comprises a quantity of the sub-files, a combination sequence of the sub-files, secret keys corresponding to the sub-files, a storage location of the sub-files and operation authorization of the sub-files; and

the service requiring note sending the storage location and operation authorization of the sub-files to the arbitration note such that the arbitration note tracks a routine of the distributed cloud storage;

the method further comprises the following step after the service requiring note establishes and stores the index information of the file to be stored:

the service requiring note broadcasting the index information to any one of the service providing notes such that the service providing note shares the file to be stored.

Advantageously, the method further comprises the following steps after the service requiring note performs slicing and encrypting process to the file to be stored, and sends the plurality of sub-files obtained from the process to the plurality of service providing notes which sign the storage contact with the service requiring note respectively:

the arbitration note judging whether the service providing notes are time-out or not while receiving corresponding sub-files; and

if a judging result is that the service providing notes are time-out, notifying the service requiring note, querying the service providing notes that are available at the present according to authorization information and predetermined conditions fed back from the service requiring note and storing the sub-files in the service providing notes that are available;

each service providing note storing the sub-files received to accomplish the distributed cloud storage of the file to be stored comprises:

dividing the service providing notes of the set of private notes into a plurality of sub-set of notes; and

sending all the sub-files of the file to be stored to the plurality of sub-set of notes respectively for multiple backups of the file to be stored;

the method further comprises the following step after sending all the sub-files of the file to be stored to the plurality of sub-set of notes respectively for multiple backups of the file to be stored:

synchronously reading the sub-files of the file to be stored from the plurality of sub-set of notes when reading the file to be stored, wherein a reading frequency of the sub-files is set in the service providing note.

A distributed and decentralized cloud storage system is further provided in the present invention, which comprises:

a private note establishing module configured for dynamically establishing a set of private notes after a service requiring note releasing a cloud storage requirement, wherein the set of private notes comprises a plurality of service providing notes, and the service providing note provides storage space for the service requiring note;

a contact signing module configured for the service requiring note to sign a storage contact with the plurality of service providing notes of the set of private notes;

a slicing and encrypting module configured for the service requiring note to perform slicing and encrypting process to a file to be stored, and to send a plurality of sub-files obtained from the process to the plurality of service providing notes which sign the storage contact with the service requiring note respectively; and

a storage module configured for each service providing note to store the sub-files received to accomplish the distributed cloud storage of the file to be stored.

Advantageously, the system further comprises:

a management note selecting module configured for selecting at least two service providing notes from the set of private notes as an arbitration note and a finance note respectively;

an informing module configured for the service requiring note to inform the arbitration note and the finance note list information of the service providing notes that sign the storage contact with the service requiring note; and

a payment information determining module configured for the finance note to determine payment information according to the storage contact and the list information.

Advantageously, the storage contact comprises a storage cycle and service fee of the file to be stored;

the system further comprises:

an actually paying module configured for the finance note to actually pay service fee according to the payment information when the storage cycle of the file to be stored ends; and

a quality evaluating module configured for the arbitration note to inform the finance note to evaluate quality of service of the service requiring note and each service providing note.

Advantageously, the system further comprises:

an index information storage module configured for the service requiring note to establish and store index information of the file to be stored, wherein the index information comprises a quantity of the sub-files, a combination sequence of the sub-files, secret keys corresponding to the sub-files, a storage location of the sub-files and operation authorization of the sub-files; and

an index information sharing module configured for the service requiring note to send the storage location and operation authorization of the sub-files to the arbitration note such that the arbitration note tracks a routine of the distributed cloud storage.

Advantageously, the system further comprises:

a file sharing module configured for the service requiring note to broadcast the index information to any one of the service providing notes such that the service providing note shares the file to be stored.

Advantageously, the system further comprises:

a time-out judging module configured for the arbitration note to judge whether the service providing notes are time-out or not while receiving corresponding sub-files; and

a time-out processing module configured for if a judging result is that the service providing notes are time-out, notifying the service requiring note, querying the service providing notes that are available at the present according to authorization information and predetermined conditions fed back from the service requiring note and storing the sub-files in the service providing notes that are available;

an ID generating module configured for the service requiring note to generate an ID that identifies the service requiring note according to at least a pair of preset private key and public key, and for the service providing note to generate an ID that identifies the service providing note according to at least a pair of preset private key and public key.

Advantageously, the storage module is configured for:

dividing the service providing notes of the set of private notes into a plurality of sub-set of notes; and

sending all the sub-files of the file to be stored to the plurality of sub-set of notes respectively for multiple backups of the file to be stored;

the system further comprises:

a reading module configured for synchronously reading the sub-files of the file to be stored from the plurality of sub-set of notes when reading the file to be stored;

a reading frequency setting module configured for the service providing module to set a threshold for the reading frequency of the sub-files.

Compared with the prior art, the distributed and decentralized cloud storage method of the present invention generates a set of private notes by randomly selecting a plurality of service providing notes, and then the service requiring note signs the storage contact with a plurality of service providing notes, and performs slicing and encrypting process to the file to be stored, and finally the plurality of sub-files obtained are stored in the plurality of service providing notes respectively so as to realize distributed cloud storage of the file to be stored. Moreover, the storage method is not based on some center to realize management or forward any more, but accomplished directly by P2P communication among the plurality of notes. Thus, the low accessing speed problem of the centralized cloud storage method is solved. Meanwhile, since the service requiring note is unfamiliar with the plurality of service providing notes, and the service requiring note performs slicing and encrypting process to the file to be stored, the problem of unsecured privacy during storage is solved to improve the security of cloud storage.

### BRIEF DESCRIPTION OF THE DRAWINGS

FIG. 1 is a schematic flow diagram of a distributed and decentralized cloud storage method according to a first embodiment of the present invention;

FIG. 2 is a schematic flow diagram of a distributed and decentralized cloud storage method according to the first embodiment of the present invention;

FIG. 3 is a schematic view of a set of private notes in the distributed and decentralized cloud storage method according to one embodiment of the present invention;

FIG. 4 is a schematic flow diagram of the distributed and decentralized cloud storage method when reading data;

FIG. 5 is a structural block diagram of a distributed and decentralized cloud storage system according to the first embodiment of the present invention;

FIG. 6 is a structural block diagram of a distributed and decentralized cloud storage system according to a second embodiment of the present invention.

The realization of the object, the functional characteristics and advantages of the present invention will be further described with reference to the embodiments and accompanying drawings.

### DETAILED DESCRIPTION OF THE EMBODIMENTS

The preferred embodiments of present invention will now be more particularly described with reference to the accompanying drawings. It should be understood that the preferred embodiments described herein are for better understanding and explaining the present invention and should not limit the present invention. Moreover, the embodiments of the present invention and the characteristics in the embodiments can be combined with each other without conflict.

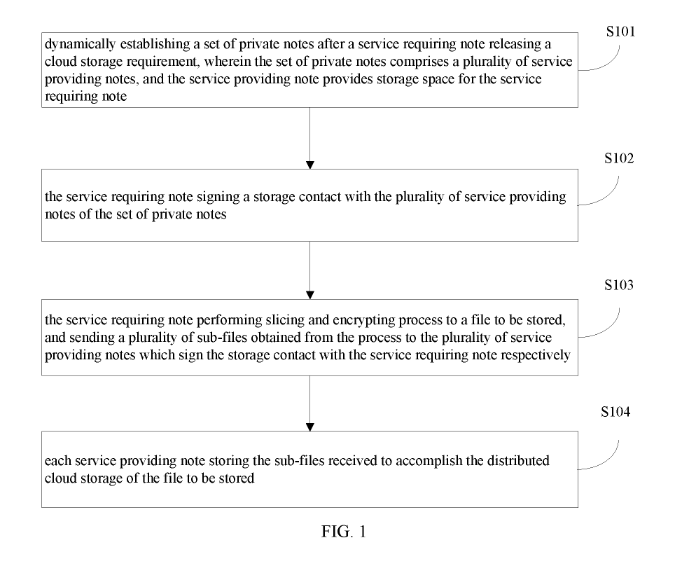

Referring to FIG. 1, FIG. 1 is a schematic flow diagram of a distributed and decentralized cloud storage method according to a first embodiment of the present invention. As shown in FIG. 1, the method comprises the following steps:

Step S101, dynamically establishing a set of private notes after a service requiring note releasing a cloud storage requirement, wherein the set of private notes comprises a plurality of service providing notes, and the service providing note provides storage space for the service requiring note.

The service requiring note is a client that needs distributed cloud storage for the file, and the service providing note is a client that has storage space and can provide the storage space for the service requiring note. Please note that for a certain client, it can serve as a service requiring note in one distributed cloud storage process, and can also serve as a service providing note in another distributed cloud storage process, as long as the client application or server application is downloaded and the client has been registered. When the client has downloaded the client application and is locally registered, it services as a service requiring note. After logging on the client application, the user can buy digital money and recharge into its account. The digital money can used to buy the distributed cloud storage space. When the client has downloaded the server application and is locally registered, it services as a service providing note. After logging on the client application, the user can set the charging standard for its storage space and set the time available for providing service. After the service providing note provides storage space for the service requiring note, the service providing note can receive digital money.

Specifically, the process for dynamically establishing a set of private notes is: dynamically selecting several or a preset number of service providing notes from the service providing notes available to generate a set of private notes, wherein the service providing notes can be selected according to a preset rule or randomly. There is a plurality of preset rules, such as selecting according to the priority of historical evaluations of the service providing notes. The historical evaluation comprises the parameters of network loyalty (such as the number of digital money held, holding time, service time), total score (such as dispersibility of the service notes, service stable index and latest ratings and so on).

Step 102, the service requiring note signing a storage contact with the plurality of service providing notes of the set of private notes.

For example, the set of private notes comprises M service providing notes, and then the service requiring note can sign the storage contact with the M service providing notes.

Step 103, the service requiring note performing slicing and encrypting process to a file to be stored, and sending a plurality of sub-files obtained from the process to the plurality of service providing notes which sign the storage contact with the service requiring note respectively. For example, the service requiring note divides the file to be stored into a plurality of slicing files, and then performs encrypting process to the plurality of slicing files obtained, and then stores the sub-files obtain from encrypting process in the M service providing notes that sign the storage contact with the service requiring note.

It is noted that the file to be stored may have a plurality of backups in the service providing notes. In the present invention, the file to be stored has at least 3 backups with one stored in the most stable service providing note (most of them are super note or company note), another one stored in the nearest service providing note (such as the one with the same region and the same supplier), and another one stored in the farthest service providing note (such as choosing the farthest geographical position via IP, for example the Chinese user chooses an American note). Certainly, the number of backups can be more, such as 7 backups with 3 backups stored in the most stable service providing note, 2 backups stored in the nearest service providing notes and 2 backups stored in the farthest service providing notes. The more the backups, the more the service requiring note needs to pay.

The principle of storage with multiple backups will be described by examples: if the set of private notes selected by the user comprises 90 service providing notes, all the service providing notes in the set of private notes can be divided into several sets of sub-notes. In this embodiment, the set of private notes is divided into 3 sets of sub-notes with 30 service providing notes serving as the most stable set of sub-notes, another 30 service providing notes serving as the nearest set of sub-notes, and the rest 30 service providing notes serving as the farthest set of sub-notes. When the user needs to store a 64 M video (file to be stored), the system can automatically slice the file to be stored into 1024 pieces with each file 64 k. Since it needs 3 backups for the file to be stored, it may obtain a total of 3072 slicing files. Then, each of the slicing files is encrypted according to a preset encryption algorithm to obtain corresponding sub-files. When storing, 1024 sub-files of the first backup are stored in the most stable set of sub-notes, 1024 sub-files of the second backup are stored in the nearest set of sub-notes, and 1024 sub-files of the third backup are stored in the farthest set of sub-notes. Each backup of the file to be stored adopts a consistent Hashing algorithm when it is stored in the corresponding set of sub-notes in way of distributed storage, for example the 1024 sub-files of the first backup are stored in 30 service providing notes of the most stable set of sub-notes using Hashing ring mode.

Certainly, the above correspondences between the backups and the service providing notes, between the service providing notes and all sub-files of one backup are illustrative, and other combinations may exist which are not detailed here. In addition, in order to speed up the storage with multiple backups, if one sub-file of the file to be stored has accomplished two backups, it is determined that the storage of the sub-file has accomplished, and the note that has not accomplished the storage will continue to obtain the sub-file from the service providing note that has stored the sub-file.

Step S104, each service providing note storing the sub-files received to accomplish the distributed cloud storage of the file to be stored. Since the file to be stored needs a plurality of backups, the step S104 accordingly comprises: dividing the service providing notes of the set of private notes into a plurality of sets of sub-notes; and sending all the sub-files of the file to be stored to the plurality of sets of sub-notes respectively for multiple backups of the file to be stored. When each service providing note of one set of sub-notes stores a corresponding sub-file, a first backup of the file to be stored is obtained. The file to be stored has multiple backups which is helpful to improve redundant security of cloud storage.

Compared with the prior art, the distributed and decentralized cloud storage method of the present invention generates a set of private notes by randomly selecting a plurality of service providing notes, and then the service requiring note signs the storage contact with a plurality of service providing notes, and performs slicing and encrypting process to the file to be stored, and finally the plurality of sub-files obtained are stored in the plurality of service providing notes respectively so as to realize distributed cloud storage of the file to be stored. Moreover, the storage method is not based on some center to realize management or forward any more, but accomplished directly by P2P communication among the plurality of notes. Thus, the low accessing speed problem of the centralized cloud storage method is solved. Meanwhile, since the service requiring note is unfamiliar with the plurality of service providing notes, and the service requiring note performs slicing and encrypting process to the file to be stored, the problem of unsecured privacy during storage is solved to improve the security of cloud storage.

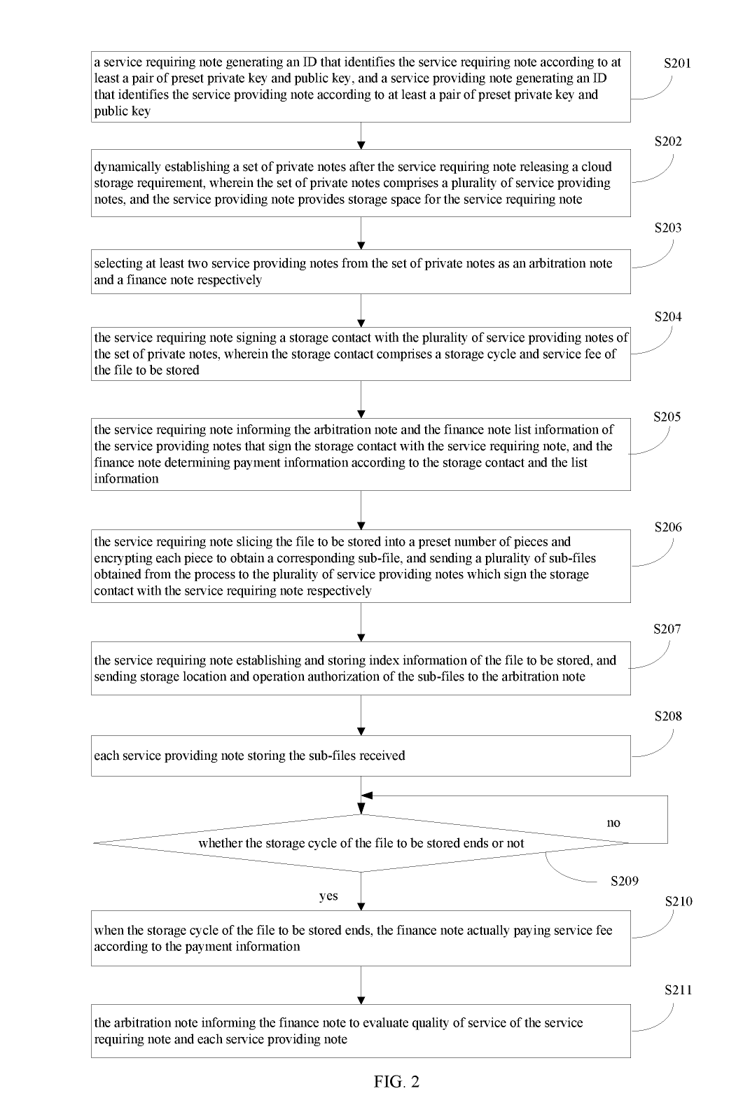

Referring to FIG. 2, FIG. 2 is a schematic flow diagram of a distributed and decentralized cloud storage method according to a second embodiment of the present invention. As shown in FIG. 2, the method comprises the following steps:

Step S201, a service requiring note generating an ID that identifies the service requiring note according to at least a pair of preset private key and public key, and a service providing note generating an ID that identifies the service providing note according to at least a pair of preset private key and public key.

For example, generating the ID according to the private key and the public key of the at least a pair of private key and public key. The at least one pair of private key and public key of the service requiring note is used to perform one or multiple asymmetric encryptions to the file to be stored to ensure data security.

Step S202, dynamically establishing a set of private notes after the service requiring note releasing a cloud storage requirement, wherein the set of private notes comprises a plurality of service providing notes, and the service providing note provides storage space for the service requiring note.

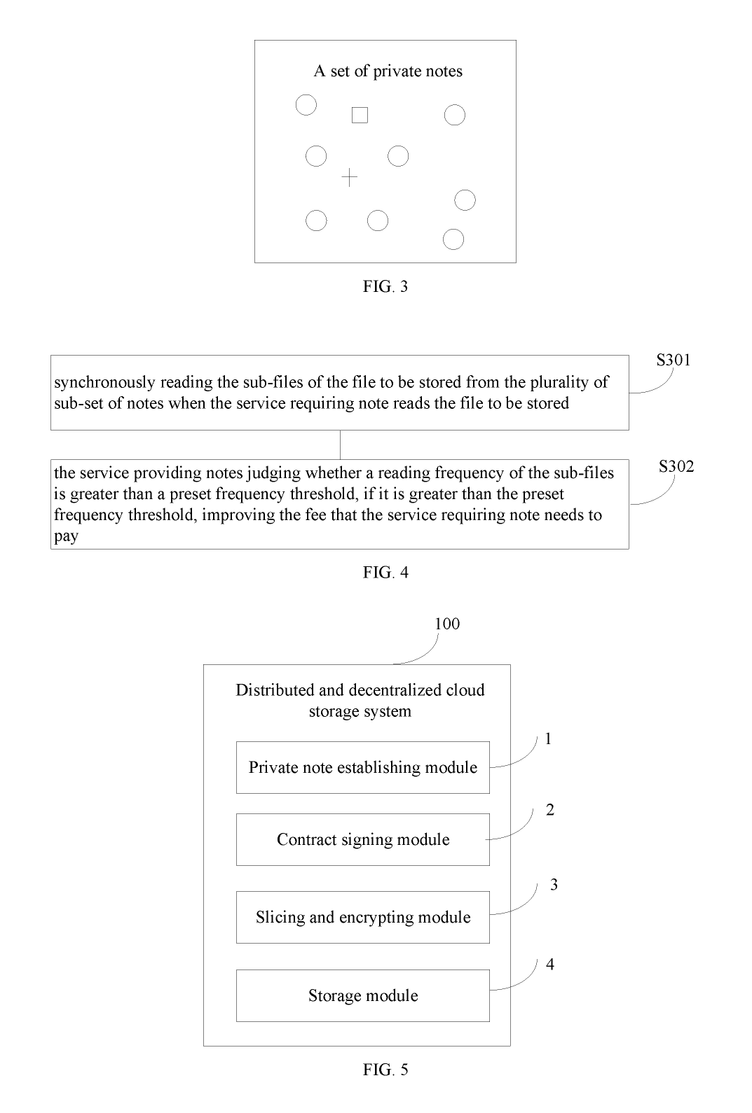

Referring to FIG. 3, FIG. 3 is a schematic view of a set of private notes according to one embodiment of the present invention. As shown in FIG. 3, in this embodiment, the set of private note comprises 10 service providing notes (labeled as a round ring).

Step S203, selecting at least two service providing notes from the set of private notes as an arbitration note and a finance note respectively.

The arbitration note is used to monitor and manage the distributed cloud storage process initiated by the service requiring note, and the finance note is used to manage the fee information during the distributed cloud storage process initiated by the service requiring note. By setting the arbitration note and the finance note, the quality of service of the storage service can efficiently be managed. In addition, when selecting the arbitration note and the finance note, it can be selected according to the stability of each service providing note. The service providing notes with higher stability are firstly selected as the arbitration note and the finance note. There may be a plurality of standards to evaluate the stability, and the parameters such as the time that the note participates into the service, the digital money held and so on can used to evaluate the stability.

For example, randomly selecting a servicing providing note from the set of private notes shown in FIG. 3 as the arbitration note (labeled as crisscross for distinguishing) and randomly selecting a servicing providing note from the set of private notes as the finance note (labeled as square for distinguishing). Understandably, the number of the arbitration note and the finance note may be several, such as selecting 3 service providing notes as the finance note respectively. When there are several finance notes, the payment security is ensured. For example, if 3 finance notes are set, the actual payment will perform only when all the three finance notes sign to agree with payment.

Step S204, the service requiring note signing a storage contact with the arbitration note, the finance note and the plurality of service providing notes of the set of private notes beside the arbitration note and the finance note.

The storage contact comprises the information such as a storage cycle and service fee (the fee that the service requiring note need to pay) of the file to be stored and quality of service and so on. For example, when the set of private note is shown as FIG. 3 and the number of the arbitration note and the finance note each is one, the service requiring note may sign the storage contact with the arbitration note, the finance note and the rest 8 service providing notes or at least 8 service notes.

Step S205, the service requiring note informing the arbitration note and the finance note list information of the service providing notes that sign the storage contact with the service requiring note, and the finance note determining payment information according to the storage contact and the list information.

It is noted that the finance note will deduct the service fee from the account of the service requiring note after the contract is signed. However, only when the storage cycle agreed on the storage contract ends, the payment will actually performed. That is to say, during the storage cycle, the service fee is temporarily saved in the finance note.

Step S206, the service requiring note slicing the file to be stored into a preset number of pieces and encrypting each piece to obtain a corresponding sub-file, and sending a plurality of sub-files obtained from the process to the plurality of service providing notes which sign the storage contact with the service requiring note respectively.

Step S207, the service requiring note establishing and storing index information of the file to be stored, and sending storage location and operation authorization of the sub-files to the arbitration note.

The arbitration note may track a routine of the distributed cloud storage according to the index information. The index information comprises a quantity of the sub-files, a combination sequence of the sub-files, secret keys corresponding to the sub-files, a storage location of the sub-files and operation authorization of the sub-files. The storage location of the sub-files shows which service providing note the sub-files are stored in. The operation authorization comprises several authorizations, such as read-only authorization. When the arbitration note knows the storage location and operation authorization of the sub-files, it can perform real-time tracking and management of the sub-files. For example, the arbitration note may judge whether the service providing notes are time-out or not while receiving corresponding sub-files; and if a judging result is that the service providing notes are time-out, the arbitration note notifies the service requiring note, queries the service providing notes that are available at the present according to authorization information and predetermined conditions fed back from the service requiring note and stores the sub-files in the service providing notes that are available. That is to say, when a certain service providing note is time-out, another service providing note will be queried to store corresponding sub-files.

In addition, when the user needs to share the file to be stored, the service requiring note may broadcast the index information to the corresponding service providing notes, and the service providing notes can look out the sub-files of the file to be stored according to the index information, and recover the complete file to be stored according to the combination sequence, and decrypt according to secret key such that the sharing of the file to be stored is realized.

After receiving the index information, the service providing note will add the index information into its file content, and keep pace with the service requiring note (i.e. the provider of the index information). For example, after the service requiring note updates the index information of file to be stored, the service requiring note still has the authority to cancel the sharing authority and cancel the sharing to the service providing notes.

Step S208, each service providing note storing the sub-files received.

Step S209, the arbitration note judging whether the storage cycle of the file to be stored ends or not, and if the storage cycle ends, executing step S210 otherwise repeatedly executing step S209.

Step S210, when the storage cycle of the file to be stored ends, the finance note actually paying service fee according to the payment information.

Step S211, the arbitration note informing the finance note to evaluate quality of service of the service requiring note and each service providing note.

Since the service requiring note and the service providing note both have a unique ID, the ID can be used to identify the service requiring note and all the service providing notes during one service. Moreover, each note will receive a corresponding quality of service evaluation during each distributed cloud storage service. This quality of service evaluation can be used as an evidence to select the service requiring note or service providing note in the following.

In addition, when the data of the file to be stored changes, the service requiring note first needs to calculate the difference of each sub-file in units of local sub-files, and then broadcasts the contents that comprise the difference to the service providing notes. Based on the non-modifiability of the service providing notes during the distributed cloud storage, all the modification records of each file will be reserved until the file is completely deleted.

Referring to FIG. 4, FIG. 4 is a schematic flow diagram of reading data after the distributed and decentralized cloud storage method of the present invention executes the storage process shown in FIGS. 1 and 2. As shown in FIG. 4, the method for reading data comprises the following steps:

Step S301, synchronously reading the sub-files of the file to be stored from the plurality of sub-set of notes when the service requiring note reads the file to be stored. For example, if the file to be stored comprises 1024 sub-files and the 1024 sub-files are all stored in 5 sets of sub-notes at the same time, the service requiring note may synchronously read different data from the 5 sets of sub-notes. For example, reading the first sub-file from the first set of sub-notes, and reading the second sub-file from the second set of sub-notes at the same time, and so forth. When finishing reading a certain sub-file, the service requiring note reads a next sub-file from the set of sub-note corresponding to the sub-file having been read out. Thus, it realizes synchronously reading of 5 data, which speeds up the data reading speed. Using the method of synchronously reading data from multiple sets of sub-notes, when finishing reading the whole file to be stored, the faster the process speed of the sub-note, the more sub-files it provides. Furthermore, the integrity of the file to be stored can be verified according to the index information of step S207 after reading.

Step S302, the service providing notes judging whether a reading frequency of the sub-files is greater than a preset frequency threshold, if it is greater than the preset frequency threshold, improving the fee that the service requiring note needs to pay. Specifically, for a same sub-file, the reading frequency threshold can be set as 10 times/hour, 30 times/day, 100 times/month and so on. If a reading frequency of the sub-file is greater than the preset frequency threshold, an additional fee can be charged according to the bandwidth. By limiting the reading frequency, it can reduce downloading load and the influence on the services of other users.

Compared with the prior art, the distributed and decentralized cloud storage method in the present embodiment has the following advantageous:

(1) The service requiring note dynamically establishes a set of private notes after releasing a cloud storage requirement, and then the file to be stored of the service requiring note is stored in the service providing notes. This storage process is not based on some center to realize management or forward any more, but accomplished directly by P2P communication among the plurality of notes. Thus, the low accessing speed problem of the centralized cloud storage method is solved. Meanwhile, since the service requiring note is unfamiliar with the plurality of service providing notes, and the service requiring note performs slicing and encrypting process to the file to be stored, the problem of unsecured privacy during storage is solved to improve the security of cloud storage.

(2) The service requiring note and the service providing note each generates an ID according to at least a pair of private key and public key set by its own user, and the ID is used to identify each note during the following cloud storage process, thus it can realize anonymous service. Meanwhile, the service requiring note performs one or multiple asymmetric encryptions to the file to be stored according to the at least one pair of private key and public key. Thus the data security is further ensured and the data privacy is better protected. However, no management center is needed to authorize and authenticate.

(3) The quality of service is better ensured by selecting some service providing notes as arbitration note to trace and manage cloud storage service, selecting some service providing notes as finance note to manage the service fee generated during the cloud storage process, and trading via digital money.

(4) It can improve the data reading speed and redundant security by making multiple backups for the file to be stored and synchronously reading data with different locations from the multiple backups. Further, by setting the reading frequency threshold for the data to be read, it can limit the download load of the system and ensure quality of service.

Furthermore, the present invention still provides a distributed and decentralized cloud storage system. Referring to FIG. 5, FIG. 5 is a structural block diagram of a distributed and decentralized cloud storage system according to the first embodiment of the present invention. As shown in FIG. 5, the distributed and decentralized cloud storage system 100 comprises a private note establishing module 1, a contact signing module 2, a slicing and encrypting module 3, and a storage module 4.

The private note establishing module 1 is configured for dynamically establishing a set of private notes after a service requiring note releasing a cloud storage requirement, wherein the set of private notes comprises a plurality of service providing notes, and the service providing note provides storage space for the service requiring note.

Specifically, the service requiring note is a client that needs distributed cloud storage for the file, and the service providing note is a client that has storage space and can provide the storage space for the service requiring note. Please note that for a certain client, it can serve as a service requiring note in one distributed cloud storage process, and can also serve as a service providing note in another distributed cloud storage process, as long as the client application or server application is downloaded and the client has been registered. When the client has downloaded the client application and is locally registered, it services as a service requiring note. After logging on the client application, the user can buy digital money and recharge into its account. The digital money can used to buy the distributed cloud storage space. When the client has downloaded the server application and is locally registered, it services as a service providing note. After logging on the client application, the user can set the charging standard for its storage space and set the time available for providing service. After the service providing note provides storage space for the service requiring note, the service providing note can receive digital money.

Advantageously, the private note establishing module is specifically configured for: dynamically selecting several or a preset number of service providing notes from the service providing notes available to generate a set of private notes, wherein the service providing notes can be selected according to a preset rule or randomly. There is a plurality of preset rules, such as selecting according to the priority of historical evaluations of the service providing notes. The historical evaluation comprises the parameters of network loyalty (such as the number of digital money held, holding time, service time), total score (such as dispersibility of the service notes, service stable index and latest ratings and so on).

The contact signing module 2 is configured for the service requiring note to sign a storage contact with the plurality of service providing notes of the set of private notes. For example, the set of private notes comprises M service providing notes, and then the service requiring note can sign the storage contact with the M service providing notes.

The slicing and encrypting module 3 is configured for the service requiring note to perform slicing and encrypting process to a file to be stored, and to send a plurality of sub-files obtained from the process to the plurality of service providing notes which sign the storage contact with the service requiring note respectively.

For example, the service requiring note divides the file to be stored into a plurality of slicing files, and then performs encrypting process to the plurality of slicing files obtained, and then stores the sub-files obtain from encrypting process in the M service providing notes that sign the storage contact with the service requiring note.

It is noted that the file to be stored may have a plurality of backups in the service providing notes. In the present invention, the file to be stored has at least 3 backups with one stored in the most stable service providing note (most of them are super note or company note), another one stored in the nearest service providing note (such as the one with the same region and the same supplier), and another one stored in the farthest service providing note (such as choosing the farthest geographical position via IP, for example the Chinese user chooses an American note). Certainly, the number of backups can be more, such as 7 backups with 3 backups stored in the most stable service providing note, 2 backups stored in the nearest service providing notes and 2 backups stored in the farthest service providing notes. The more the backups, the more the service requiring note needs to pay.

The principle of storage with multiple backups will be described by examples: if the set of private notes selected by the user comprises 90 service providing notes, all the service providing notes in the set of private notes can be divided into several sets of sub-notes. In this embodiment, the set of private notes is divided into 3 sets of sub-notes with 30 service providing notes serving as the most stable set of sub-notes, another 30 service providing notes serving as the nearest set of sub-notes, and the rest 30 service providing notes serving as the farthest set of sub-notes. When the user needs to store a 64 M video (file to be stored), the system can automatically slice the file to be stored into 1024 pieces with each file 64 k. Since it needs 3 backups for the file to be stored, it may obtain a total of 3072 slicing files. Then, each of the slicing files is encrypted according to a preset encryption algorithm to obtain corresponding sub-files. When storing, 1024 sub-files of the first backup are stored in the most stable set of sub-notes, 1024 sub-files of the second backup are stored in the nearest set of sub-notes, and 1024 sub-files of the third backup are stored in the farthest set of sub-notes. Each backup of the file to be stored adopts a consistent Hashing algorithm when it is stored in the corresponding set of sub-notes in way of distributed storage, for example the 1024 sub-files of the first backup are stored in 30 service providing notes of the most stable set of sub-notes using Hashing ring mode.

Certainly, the above correspondences between the backups and the service providing notes, between the service providing notes and all sub-files of one backup are illustrative, and other combinations may exist which are not detailed here. In addition, in order to speed up the storage with multiple backups, if one sub-file of the file to be stored has accomplished two backups, it is determined that the storage of the sub-file has accomplished, and the note that has not accomplished the storage will continue to obtain the sub-file from the service providing note that has stored the sub-file.

The storage module 4 is configured for each service providing note to store the sub-files received to accomplish the distributed cloud storage of the file to be stored. Since the file to be stored needs a plurality of backups, the storage module 4 is specifically configured for: dividing the service providing notes of the set of private notes into a plurality of sets of sub-notes; and sending all the sub-files of the file to be stored to the plurality of sets of sub-notes respectively for multiple backups of the file to be stored. When each service providing note of one set of sub-notes stores a corresponding sub-file, a first backup of the file to be stored is obtained. The file to be stored has multiple backups which is helpful to improve redundant security of cloud storage.

Compared with the prior art, the distributed and decentralized cloud storage system of the present invention generates a set of private notes by selecting a plurality of service providing notes by the private note establishing module 1, and then the service requiring note signs the storage contact with a plurality of service providing notes via the contract signing module 2, and performs slicing and encrypting process to the file to be stored via the slicing and encrypting module 3, and finally the plurality of sub-files obtained are stored in the plurality of service providing notes respectively via the storage module 4 so as to realize distributed cloud storage of the file to be stored. Moreover, the storage method is not based on some center to realize management or forward any more, but accomplished directly by P2P communication among the plurality of notes. Thus, the low accessing speed problem of the centralized cloud storage method is solved. Meanwhile, since the service requiring note is unfamiliar with the plurality of service providing notes, and the service requiring note performs slicing and encrypting process to the file to be stored, the problem of unsecured privacy during storage is solved to improve the security of cloud storage.

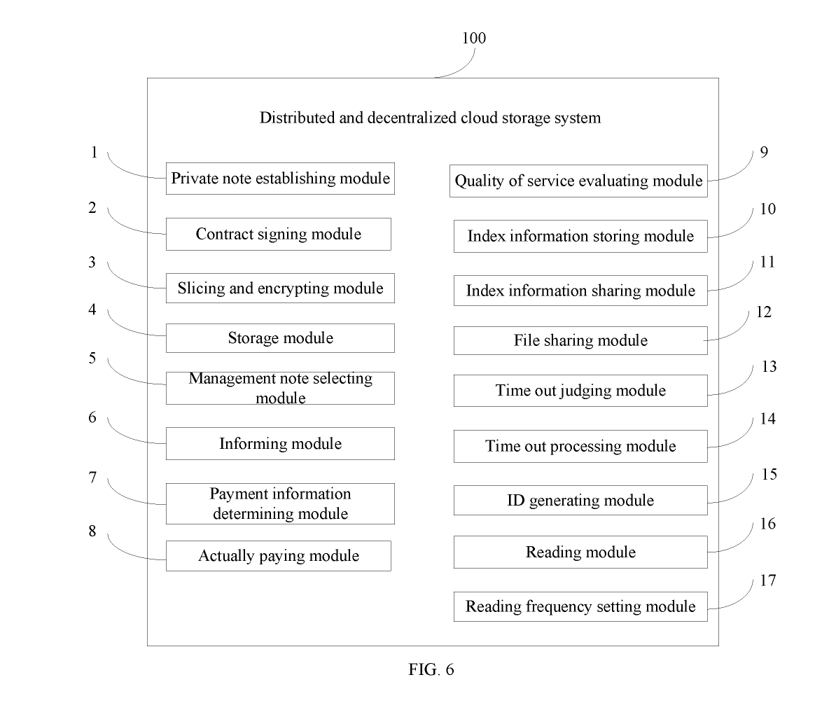

Referring to FIG. 6, FIG. 6 is a structural block diagram of a distributed and decentralized cloud storage system according to a second embodiment of the present invention. As shown in FIG. 6, the distributed and decentralized cloud storage system 100 comprises a private note establishing module 1, a contract signing module 2, a slicing and encrypting module 3, a storage module 4, management note selecting module 5, informing module 6, payment information determining module 7, actually paying module 8, quality of service evaluating module 9, index information storing module 10, index information sharing module 11, file sharing module 12, time out judging module 13, time out processing module 14, ID generating module 15, reading module 16, and reading frequency setting module 17.

The private note establishing module 1, the contract signing module 2, the slicing and encrypting module 3 and the storage module 4 are the same as the private note establishing module 1, the contract signing module 2, the slicing and encrypting module 3 and the storage module 4 of the embodiment shown in FIG. 4, which will not be detailed here. Preferably, the storage contact comprises the information such as a storage cycle and service fee (the fee that the service requiring note need to pay) of the file to be stored and quality of service and so on.

The functions of above modules will be described in detail in the following:

The ID generating module 15 is configured for the service requiring note to generate an ID that identifies the service requiring note according to at least a pair of preset private key and public key, and for the service providing note to generate an ID that identifies the service providing note according to at least a pair of preset private key and public key. For example, generating the ID according to the private key and the public key of the at least a pair of private key and public key. The at least one pair of private key and public key of the service requiring note is used to perform an or multiple asymmetric encryptions to the file to be stored to ensure data security.

The management note selecting module 5 is configured for selecting at least two service providing notes from the set of private notes as an arbitration note and a finance note respectively. The arbitration note is used to monitor and manage the distributed cloud storage process initiated by the service requiring note, and the finance note is used to manage the fee information during the distributed cloud storage process initiated by the service requiring note. By setting the arbitration note and the finance note, the quality of service of the storage service can efficiently be managed. In addition, when selecting the arbitration note and the finance note, it can be selected according to the stability of each service providing note. The service providing notes with higher stability are firstly selected as the arbitration note and the finance note. There may be a plurality of standards to evaluate the stability, and the parameters such as the time that the note participates into the service, the digital money held and so on can used to evaluate the stability. For example, randomly selecting a servicing providing note from the set of private notes shown in FIG. 3 as the arbitration note (labeled as crisscross for distinguishing) and randomly selecting a servicing providing note from the set of private notes as the finance note (labeled as square for distinguishing). Understandably, the number of the arbitration note and the finance note may be several, such as selecting 3 service providing notes as the finance note respectively. When there are several finance notes, the payment security is ensured. For example, if 3 finance notes are set, the actual payment will perform only when all the three finance notes sign to agree with payment.

The informing module 6 is configured for the service requiring note to inform the arbitration note and the finance note the list information of the service providing notes that sign the storage contract with the service requiring note.

The payment information determining module 7 is configured for the finance note to determine the payment information according to the storage contract and the list information.

The actually paying module 8 is configured for actually paying the service fee according to the payment information when the storage cycle of the file to be stored ends. It is noted that the finance note will deduct the service fee from the account of the service requiring note after the contract is signed. However, only when the storage cycle agreed on the storage contract ends, the payment will actually performed. That is to say, during the storage cycle, the service fee is temporarily saved in the finance note.

The quality of service evaluating module 9 is configured for the arbitration note to inform the finance note to evaluate the quality of service of the service requiring note and the service providing notes. Since the service requiring note and the service providing note both have a unique ID, the ID can be used to identify the service requiring note and all the service providing notes during one service. Moreover, each note will receive a corresponding quality of service evaluation during each distributed cloud storage service. This quality of service evaluation can be used as an evidence to select the service requiring note or service providing note in the following.

The index information storage module 10 is configured for the service requiring note to establish and store index information of the file to be stored. The index information comprises a quantity of the sub-files, a combination sequence of the sub-files, secret keys corresponding to the sub-files, a storage location of the sub-files and operation authorization of the sub-files. The storage location of the sub-files shows which service providing note the sub-files are stored in. The operation authorization comprises several authorizations, such as read-only authorization.

The index information sharing module 11 is configured for the service requiring note to send the storage location and operation authorization of the sub-files to the arbitration note such that the arbitration note tracks a routine of the distributed cloud storage. When the arbitration note knows the storage location and operation authorization of the sub-files, it can perform real-time tracking and management of the sub-files. For example, the arbitration note may judge whether the service providing notes are time-out or not while receiving corresponding sub-files; and if a judging result is that the service providing notes are time-out, the arbitration note notifies the service requiring note, queries the service providing notes that are available at the present according to authorization information and predetermined conditions fed back from the service requiring note and stores the sub-files in the service providing notes that are available. That is to say, when a certain service providing note is time-out, another service providing note will be queried to store corresponding sub-files.

The file sharing module 12 is configured for the service requiring note to broadcast the index information to any one of service providing notes such that the service providing note shares the file to be stored. When the user needs to share the file to be stored, the service requiring note may broadcast the index information to the corresponding service providing notes, and the service providing notes can look out the sub-files of the file to be stored according to the index information, and recover the complete file to be stored according to the combination sequence, and decrypt according to secret key such that the sharing of the file to be stored is realized. After receiving the index information, the service providing note will add the index information into its file content, and keep pace with the service requiring note (i.e. the provider of the index information). For example, after the service requiring note updates the index information of file to be stored, the service requiring note still has the authority to cancel the sharing authority and cancel the sharing to the service providing notes.

The time out judging module 13 is configured for the arbitration note to judge whether the service providing notes are time-out or not when receiving a corresponding sub-file.

The time out processing module 14 is configured for the arbitration note to notify the service requiring note when the service providing notes are time-out and query the service providing notes that are available at the present according to authorization information and predetermined conditions fed back from the service requiring note and stores the sub-files in the service providing notes that are available.

The reading module 14 is configured for synchronously reading the sub-files of the file to be stored from the plurality of sub-set of notes when the service requiring note reads the file to be stored. For example, if the file to be stored comprises 1024 sub-files and the 1024 sub-files are all stored in 5 sets of sub-notes at the same time, the service requiring note may synchronously read different data from the 5 sets of sub-notes. For example, reading the first sub-file from the first set of sub-notes, and reading the second sub-file from the second set of sub-notes at the same time, and so forth. When finishing reading a certain sub-file, the service requiring note reads a next sub-file from the set of sub-note corresponding to the sub-file having been read out. Thus, it realizes synchronously reading of 5 data, which speeds up the data reading speed. Using the method of synchronously reading data from multiple sets of sub-notes, when finishing reading the whole file to be stored, the faster the process speed of the sub-note, the more sub-files it provides. Furthermore, the integrity of the file to be stored can be verified according to the index information in the index information storage module 10 after reading.

The reading frequency setting module 17 is configured for the service providing module to set a reading frequency threshold of the sub-files to be read. The service providing notes may judge whether a reading frequency of the sub-files is greater than a preset frequency threshold, if it is greater than the preset frequency threshold, improving the fee that the service requiring note needs to pay. Specifically, for a same sub-file, the reading frequency threshold can be set as 10 times/hour, 30 times/day, 100 times/month and so on. If a reading frequency of the sub-file is greater than the preset frequency threshold, an additional fee can be charged according to the bandwidth. By limiting the reading frequency, it can reduce downloading load and the influence on the services of other users.

In addition, the distributed and decentralized cloud storage system 100 of the present embodiment may further comprises an updating module configured for the service requiring note first to calculate the difference of each sub-file in units of local sub-files when the data of the file to be stored changes, and then to broadcast the contents that comprise the difference to the service providing notes. Based on the non-modifiability of the service providing notes during the distributed cloud storage, all the modification records of each file will be reserved until the file is completely deleted.

Compared with the prior art, the distributed and decentralized cloud storage method in the present embodiment has the following advantageous:

(1) The service requiring note dynamically establishes a set of private notes after releasing a cloud storage requirement, and then the file to be stored of the service requiring note is stored in the service providing notes. This storage process is not based on some center to realize management or forward any more, but accomplished directly by P2P communication among the plurality of notes. Thus, the low accessing speed problem of the centralized cloud storage method is solved. Meanwhile, since the service requiring note is unfamiliar with the plurality of service providing notes, and the service requiring note performs slicing and encrypting process to the file to be stored, the problem of unsecured privacy during storage is solved to improve the security of cloud storage.

(2) The service requiring note and the service providing note each generates an ID according to at least a pair of private key and public key set by its own user, and the ID is used to identify each note during the following cloud storage process, thus it can realize anonymous service. Meanwhile, the service requiring note performs one or multiple asymmetric encryptions to the file to be stored according to the at least one pair of private key and public key. Thus the data security is further ensured and the data privacy is better protected. However, no management center is needed to authorize and authenticate.

(3) The quality of service is better ensured by selecting some service providing notes as arbitration note to trace and manage cloud storage service, selecting some service providing notes as finance note to manage the service fee generated during the cloud storage process, and trading via digital money.

(4) It can improve the data reading speed and redundant security by making multiple backups for the file to be stored and synchronously reading data with different locations from the multiple backups. Further, by setting the reading frequency threshold for the data to be read, it can limit the download load of the system and ensure quality of service.

It is noted that the modules in the embodiments shown in FIGS. 5 and 6 are functionally limited. However, in actual application, the functions may realized respectively by the service requiring note, the service providing note, the arbitration note or the finance note according to specific function of each module.

Abovementioned are only preferred embodiments of the present invention, which are not provided to limit the patent scope of the present invention. Equivalent structural or equivalent flow changes made according to the specification and accompanying drawings of the present invention, or directly or indirectly applications in other related technical fields are equally included in the patent protection scope of the present invention.

What is claimed is:

1. A distributed and decentralized cloud storage method, comprising the following steps:
dynamically establishing a set of private notes after a service requiring note releasing a cloud storage requirement, wherein the set of private notes comprises a plurality of service providing notes, and the service providing note provides storage space for the service requiring note;
the service requiring note signing a storage contact with the plurality of service providing notes of the set of private notes;
the service requiring note performing slicing and encrypting process to a file to be stored, and sending a plurality of sub-files obtained from the process to the plurality of service providing notes which sign the storage contact with the service requiring note respectively; and
each service providing note storing the sub-files received to accomplish the distributed cloud storage of the file to be stored.

2. The distributed and decentralized cloud storage method of claim 1, wherein, the method further comprises the following step after dynamically establishing the set of private notes:
selecting at least two service providing notes from the set of private notes as an arbitration note and a finance note respectively; and
the method further comprises the following step after the service requiring note signs a storage contact with the plurality of service providing notes of the set of private notes:
the service requiring note informing the arbitration note and the finance note list information of the service providing notes that sign the storage contact with the service requiring note, and the finance note determining payment information according to the storage contact and the list information.

3. The distributed and decentralized cloud storage method of claim 2, wherein the storage contact comprises a storage cycle and service fee of the file to be stored;
the method further comprises the following steps after each service providing note stores the sub-files received to accomplish the distributed cloud storage of the file to be stored:
the finance note actually paying service fee according to the payment information when the storage cycle of the file to be stored ends; and
the arbitration note informing the finance note to evaluate quality of service of the service requiring note and each service providing note.

4. The distributed and decentralized cloud storage method of claim 2, wherein the method further comprises the following steps after the service requiring note performs slicing and encrypting process to the file to be stored, and sends the plurality of sub-files obtained from the process to the plurality of service providing notes which sign the storage contact with the service requiring note respectively:
the service requiring note establishing and storing index information of the file to be stored, wherein the index information comprises a quantity of the sub-files, a combination sequence of the sub-files, secret keys corresponding to the sub-files, a storage location of the sub-files and operation authorization of the sub-files; and
the service requiring note sending the storage location and operation authorization of the sub-files to the arbitration note such that the arbitration note tracks a routine of the distributed cloud storage.

5. The distributed and decentralized cloud storage method of claim 4, wherein the method further comprises the following step after the service requiring note establishes and stores index information of the file to be stored:
the service requiring note broadcasting the index information to any one of the service providing notes such that the service providing note shares the file to be stored.

6. The distributed and decentralized cloud storage method of claim 5, wherein the method further comprises the following steps after the service requiring note performs slicing and encrypting process to the file to be stored, and sends the plurality of sub-files obtained from the process to the plurality of service providing notes which sign the storage contact with the service requiring note respectively:
the arbitration note judging whether the service providing notes are time-out or not while receiving corresponding sub-files; and
if a judging result is that the service providing notes are time-out, notifying the service requiring note, querying the service providing notes that are available at the present according to authorization information and predetermined conditions fed back from the service requiring note and storing the sub-files in the service providing notes that are available.

7. The distributed and decentralized cloud storage method of claim 1, wherein the method further comprises the following steps between the service requiring note releasing the cloud storage requirement and dynamically establishing the set of private notes:
the service requiring note generating an ID that identifies the service requiring note according to at least a pair of preset private key and public key;
the service providing note generating an ID that identifies the service providing note according to at least a pair of preset private key and public key.

8. The distributed and decentralized cloud storage method of any one of claims 1-7, wherein each service providing note storing the sub-files received to accomplish the distributed cloud storage of the file to be stored comprises:
dividing the service providing notes of the set of private notes into a plurality of sub-set of notes;
sending all the sub-files of the file to be stored to the plurality of sub-set of notes respectively for multiple backups of the file to be stored.

9. The distributed and decentralized cloud storage method of claim 8, wherein the method further comprises the following step after sending all the sub-files of the file to be stored to the plurality of sub-set of notes respectively for multiple backups of the file to be stored:
synchronously reading the sub-files of the file to be stored from the plurality of sub-set of notes when reading the file to be stored, wherein a reading frequency of the sub-files is set in the service providing note.

10. A distributed and decentralized cloud storage method, comprising the following steps:
a service requiring note generating an ID that identifies the service requiring note according to at least a pair of preset private key and public key, and a service providing note generating an ID that identifies the service providing note according to at least a pair of preset private key and public key;
dynamically establishing a set of private notes after the service requiring note releasing a cloud storage requirement, wherein the set of private notes comprises a plurality of service providing notes, and the service providing note provides storage space for the service requiring note;
selecting at least two service providing notes from the set of private notes as an arbitration note and a finance note respectively;
the service requiring note signing a storage contact with the plurality of service providing notes of the set of private notes, wherein the storage contact comprises a storage cycle and service fee of the file to be stored;
the service requiring note informing the arbitration note and the finance note list information of the service providing notes that sign the storage contact with the service requiring note, and the finance note determining payment information according to the storage contact and the list information;
the service requiring note performing slicing and encrypting process to a file to be stored, and sending a plurality of sub-files obtained from the process to the plurality of service providing notes which sign the storage contact with the service requiring note respectively;
each service providing note storing the sub-files received;
the finance note actually paying service fee according to the payment information when the storage cycle of the file to be stored ends; and
the arbitration note informing the finance note to evaluate quality of service of the service requiring note and each service providing note.

11. The distributed and decentralized cloud storage method of claim 10, wherein the method further comprises the following steps after the service requiring note performs slicing and encrypting process to the file to be stored, and sends the plurality of sub-files obtained from the process to the plurality of service providing notes which sign the storage contact with the service requiring note respectively:
the service requiring note establishing and storing index information of the file to be stored, wherein the index information comprises a quantity of the sub-files, a combination sequence of the sub-files, secret keys corresponding to the sub-files, a storage location of the sub-files and operation authorization of the sub-files; and
the service requiring note sending the storage location and operation authorization of the sub-files to the arbitration note such that the arbitration note tracks a routine of the distributed cloud storage;
the method further comprises the following step after the service requiring note establishes and stores the index information of the file to be stored:
the service requiring note broadcasting the index information to any one of the service providing notes such that the service providing note shares the file to be stored.

12. The distributed and decentralized cloud storage method of claim 10, wherein the method further comprises the following steps after the service requiring note performs slicing and encrypting process to the file to be stored, and sends the plurality of sub-files obtained from the process to the plurality of service providing notes which sign the storage contact with the service requiring note respectively:
the arbitration note judging whether the service providing notes are time-out or not while receiving corresponding sub-files; and
if a judging result is that the service providing notes are time-out, notifying the service requiring note, querying the service providing notes that are available at the present according to authorization information and predetermined conditions fed back from the service requiring note and storing the sub-files in the service providing notes that are available;
each service providing note storing the sub-files received to accomplish the distributed cloud storage of the file to be stored comprises:
dividing the service providing notes of the set of private notes into a plurality of sub-set of notes; and
sending all the sub-files of the file to be stored to the plurality of sub-set of notes respectively for multiple backups of the file to be stored;
the method further comprises the following step after sending all the sub-files of the file to be stored to the plurality of sub-set of notes respectively for multiple backups of the file to be stored:
synchronously reading the sub-files of the file to be stored from the plurality of sub-set of notes when reading the file to be stored, wherein a reading frequency of the sub-files is set in the service providing note.

13. A distributed and decentralized cloud storage system, comprising:
a private note establishing module configured for dynamically establishing a set of private notes after a service requiring note releasing a cloud storage requirement, wherein the set of private notes comprises a plurality of service providing notes, and the service providing note provides storage space for the service requiring note;
a contact signing module configured for the service requiring note to sign a storage contact with the plurality of service providing notes of the set of private notes;
a slicing and encrypting module configured for the service requiring note to perform slicing and encrypting process to a file to be stored, and to send a plurality of sub-files obtained from the process to the plurality of service providing notes which sign the storage contact with the service requiring note respectively; and
a storage module configured for each service providing note to store the sub-files received to accomplish the distributed cloud storage of the file to be stored.

14. The distributed and decentralized cloud storage system of claim 13, wherein, the system further comprises:
a management note selecting module configured for selecting at least two service providing notes from the set of private notes as an arbitration note and a finance note respectively;
an informing module configured for the service requiring note to inform the arbitration note and the finance note list information of the service providing notes that sign the storage contact with the service requiring note; and
a payment information determining module configured for the finance note to determine payment information according to the storage contact and the list information.

15. The distributed and decentralized cloud storage system of claim 14, wherein the storage contact comprises a storage cycle and service fee of the file to be stored;
the system further comprises:
an actually paying module configured for the finance note to actually pay service fee according to the payment information when the storage cycle of the file to be stored ends; and
a quality evaluating module configured for the arbitration note to inform the finance note to evaluate quality of service of the service requiring note and each service providing note.

16. The distributed and decentralized cloud storage system of claim 14, wherein the system further comprises:
an index information storage module configured for the service requiring note to establish and store index information of the file to be stored, wherein the index information comprises a quantity of the sub-files, a combination sequence of the sub-files, secret keys corresponding to the sub-files, a storage location of the sub-files and operation authorization of the sub-files; and
an index information sharing module configured for the service requiring note to send the storage location and operation authorization of the sub-files to the arbitration note such that the arbitration note tracks a routine of the distributed cloud storage.

17. The distributed and decentralized cloud storage system of claim 16, wherein the system further comprises:
a file sharing module configured for the service requiring note to broadcast the index information to any one of the service providing notes such that the service providing note shares the file to be stored.

18. The distributed and decentralized cloud storage system of claim 17, wherein the system further comprises:
a time-out judging module configured for the arbitration note to judge whether the service providing notes are time-out or not while receiving corresponding sub-files; and
a time-out processing module configured for if a judging result is that the service providing notes are time-out, notifying the service requiring note, querying the service providing notes that are available at the present according to authorization information and predetermined conditions fed back from the service requiring note and storing the sub-files in the service providing notes that are available;
an ID generating module configured for the service requiring note to generate an ID that identifies the service requiring note according to at least a pair of preset private key and public key, and for the service providing note to generate an ID that identifies the service providing note according to at least a pair of preset private key and public key.

19. The distributed and decentralized cloud storage system of any one of claims 13-18, wherein the storage module is configured for:
dividing the service providing notes of the set of private notes into a plurality of sub-set of notes; and
sending all the sub-files of the file to be stored to the plurality of sub-set of notes respectively for multiple backups of the file to be stored;
the system further comprises:
a reading module configured for synchronously reading the sub-files of the file to be stored from the plurality of sub-set of notes when reading the file to be stored;
a reading frequency setting module configured for the service providing module to set a threshold for the reading frequency of the sub-files.
